(19) United States
(12) Patent Application Publication
(10) Pub. No.: US 2006/0259975 A1
(43) Pub. Date: Nov. 16, 2006

(54) Method and system for protecting digital media from illegal copying

(75) Inventor: Eyal Cohen, Kiryat Bialik (IL)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: HEXALOCK LTD., Shfaim (IL)

(21) Appl. No.: 10/514,963

(22) PCT Filed: May 12, 2003
(86) PCT No.: PCT/IL03/00383

§ 371 Date: Jul. 11, 2005

(30) Foreign Application Priority Data
May 20, 2002 (IL) 149759

(51) Int. Cl. H04N 7/16

(52) U.S. Cl. 726/26

(57) ABSTRACT

A method for protecting digital media from illegal copying by placing in predetermined locations of the digital media a set of Logical Digital Signatures (LDS), each of which causes retrieval of a different Sense Code (SC) and comprise a different signature, and utilizing an authentication module, which contains, or has access, to the signatures, for detecting the presence of the logical errors. The method comprises activating the authentication module whenever the content of the storage media is accessed, performing read operation of the locations wherein the LDSs are located, storing the Sense Code (SC) obtained from each read operation in a memory, and allowing access to the content of said storage media if information was retrieved following the LDS read operation and it matches the information that was originally stored, as accessible by the authentication module, and if different SCs were obtained from the reading operation of the different LDSs, otherwise preventing the access to the content of the storage media.

### FIELD OF THE INVENTION

The present invention relates to the field of protecting digital content against illegal copying. More particularly, the present invention relates to a method for generating an authenticating element for digital storage media, that can be used to determine if the media is original or not.

### BACKGROUND OF THE INVENTION

Optical media such as CD-ROM and DVD had become major means for storing software due to their inherent features of, high density, reliable storage, and a relatively low price. In the past, the piracy in the copying of optical media like CD-ROM was negligible, since recordable machines were available only to professionals, due to their high price. However, in the recent years the price of recordable machines, capable of making a perfect copy of original prerecorded CDs and DVDs, has been substantially reduced. Consequently, the rate of illegal copying had substantially increased, resulting in significant damages to the software proprietors.

Compact Discs (CD) are an optical storage media of digital information widely utilized for storage of audio, video, text, and other types of digital information. Their reliability, efficiency and low price made their use very common for storage of music, movies, computer software and data. The information stored on the CD may be easily copied, and actually, it is accessible utilizing the basic tools of virtually any computer operating system. The arrival of write-able CDs (CD-R), made the pirate reproduction of CDs a very simple task.

A method and system for protecting data are disclosed in co-pending patent application, IL 142487, of the same applicant hereof, filed on Apr. 05, 2001, the description of which is incorporated herein by reference.

A copy protection system for digital media usually contains two basic elements:
1. Authenticating element—this element is located on the storage media. In order to verify the authenticity of the digital media (i.e., to distinguish between an original and a copy) it should be impossible to transfer this type of element to another media by means of copying. This element is often called “Digital Signature”.
2. Detection software—software procedures used to detect the existence of the authenticating element and allow or deny the use of the media.

In the prior art, digital signatures are based on physical damages embedded into the storage media, which resulted in areas of the media which were unreadable. Since these signatures are unreadable an error is returned whenever an attempt of reading these areas is made. This authentication technique is based on the assumption that this physical error can not be reproduced utilizing the conventional copying means.

During the authentication procedure, the detection software of a copy protection system in which physical damages are used, tries to read these unreadable areas. If these areas are unreadable an error is returned, the detection software assumes that the authenticating element exist and allow the usage of the media. On the other hand, if these areas are readable, the detection software assumes that the media is not an original because the authenticating element was removed as a result of a copy operation, in this case the detection software deny the use of the media or the content that is stored on it.

In the prior art physical digital signatures for CD-ROM are based on altering the standard structure of the CD-ROM. Examples of such changes are changing the CD track path, using non standard pit geometry and altering the parity codes that are used for internal error detection and correction of data. Each one of these signatures causes CD-ROM readers to fail reading the information from the areas where they are occurring, due to the physical damage of the media. CD-ROM readers return an error code that consists of 3 bytes of data, also known as ‘Sense Codes’. The Sense Code (SC) value indicates the reason for the failure of the drive to read the information. Since this type of physical signatures are causing the same type of read failures, namely-damaged media, the same SC is returned when attempting to read the locations wherein these signatures are placed.

In the past physical damages served well as digital signatures for CD-ROM copy protection. When a copy of an original CD was made the signature was removed because CD recorders are not designed to damage the recorded media. However, in recent years CD recorders were improved and nowadays most of the CD recorders available in the market if not all of them are capable of writing information in ‘raw mode’. Writing information in raw mode allows recording software to write erroneous information.

Examples for CD recording software that are able to write errors are CloneCD and BlindWrite. These softwares write erroneous information to the locations of the recorded media which corresponds to locations of the digital signature in the original media. The result is that the areas that contain the erroneous information are unreadable just like in the original media. The SCs which are returned due to read failures from the copy may be different from the SC returned due to a reading attempt of the same areas of the original media. In each case. the read operations are failing from different reasons:
when using the original media, the reason is damaged media; and
when using the copy the reason is erroneous information.

However, there is no way to verify which SC represents an error returned due to a read operation of a real physical error (damaged media), or if the cause of the error is erroneous information that was copied on a reproduced copy. The main reason for this uncertainty is that there are many CD readers' manufactures, and each CD reader may return a different SC corresponding to the same reading error. Although the MMC-3 (SCSI3 Multi Media Commands) standard defines the SCs values that should be returned for each type of failure, not all CD readers' manufactures follows this standard. Some manufactures choose to have a simple implementation of a CD reader in which the only important thing is to report the error, and the cause for the error is of less importance, or unimportant at all. It should be noted that a CD reader can work properly even in situations in which the wrong SCs are returned.

It is an object of the present invention to provide a method and system for protecting digital content based on creating logical digital signatures by manipulating the CD-ROM main channel information.

It is another object of the present invention to provide a method and system for differentiating an original media from a copied media, wherein the existence and behavior of plurality of logical digital signatures that are written or stamped into the protected media are checked.

It a further object of the present invention to provide a method and system for preventing identically copying original content of copy protected media utilizing logical digital signatures.

### BRIEF DESCRIPTION OF THE DRAWING

In the drawings:

FIG. 1 shows the sector format of CD-DA (Audio CD);

FIG. 2 shows the main channel data block format of a CD-ROM recorded in mode 1;

FIG. 3 is a flow chart illustrating a general process for determining the originality of a storage medium, based on two different logical signatures, according to the method of the invention ;and

FIG. 4 is a flow chart illustrating a possible embodiments of the invention for determining the originality of a storage medium utilizing Logical Digital Signatures of the 1^{st} and 2^{nd} types;

### SUMMARY OF THE INVENTION

The following terms are defined as follows:

Physical Signature—data pattern placed in locations of a digital media which may be subject to only read operations, thereby preventing reproduction of such data patterns,

Logical Signature—data pattern placed in locations of a digital media, which its structure/content causes a read error whenever such a data pattern is read. The Logical Signatures can also include unique signature information which is a signature that is difficult to copy and used to authenticate the storing media.

Authentication module—a component of the digital media which permits or prevents the access to the content stored on the digital media.

The present invention is directed to a method for protecting digital media from illegal copying by placing in predetermined locations of the digital media a set of Logical Digital Signatures (LDS), each of which causes retrieval of different Sense Code and comprise a different signature, and utilizing an authentication module which contains, or has access, to said signatures, for detecting the presence of the logical errors. The method comprises activating the authentication module whenever the content of the storage media is accessed; performing read operation of the locations wherein the LDSs are located; storing the Sense Code (SC) obtained from each read operation in a memory; and if information was retrieved following the LDS read operation and it matches the information that was originally stored, as accessible by the authentication module, and if different SCs were obtained from the reading operation of the different LDSs, allowing access to the content of the storage media. Otherwise if the same SCs were obtained from the reading operation or if the information that was retrieved is not the same as accessible by the authentication module, preventing the access to the content of the storage media.

Optionally, the access to the content of the storage media may be prevented whenever the same information is obtained from different LDSs, and/or whenever the same SCs are obtained from read operation of different types of LDSs.

According to one preferred embodiment of the invention the LDSs are placed in locations on the digital media which are not associated with any file or other content of the digital media.

According to another preferred embodiment of the invention two different LDSs are placed in predetermined locations on the digital media, and an authentication procedure is performed by the authentication module whenever the content of the digital media is accessed. The authentication procedure performed comprises: performing a first read operation from the location in which the first LDS is located, and storing the SC obtained in a memory; checking if data was retrieved by the first read operation, and if data was retrieved and the data does not match the data expected to be obtained from the first LDS preventing access to the content of the digital media; performing a second read operation from the location in which the second LDS is located, and storing the SC obtained in a memory; checking if data was retrieved by the second read operation, and if data was retrieved and the data does not match the data expected to be obtained from the second LDS preventing access to the content of the digital media; and comparing the SCs stored in the memory to determined if the SC was obtained from the first and second read operations, if it is determined that the same SCs were obtained from the first and second read operations preventing access to the content of the digital media, otherwise, if it is determined that different SCs were obtained from the first and second read operations allowing access to content of the digital media.

Optionally, the storage media is a CD-ROM.

According to another preferred embodiment of the invention the LDSs contains one or more of the following logical errors:
Type 1—EDC and ECC fields of error correcting code are zeroed;
Type 2—a negative Rom Skew; and
Type 3—the sector number in the header is zeroed.

In other preferred embodiments of the invention a logical error of Type 1 may be used in the first LDS, and a logical error of Type 2 may be used in the second LDS.

The present invention is also directed to a system for protecting digital media from illegal copying. The system comprises: a set of Logical Digital Signatures (LDS) being placed in predetermined locations of the digital media; an authentication module being activated whenever the content of the storage media is accessed; and a memory. The authentication module performs read operations of the locations wherein the LDSs are located to determine if for each read operation a different SC is obtained and to determine if information that was obtained by the read operations corresponds to those expected from the LDSs, in order to allow access to the content of the digital media.

Optionally, the access to the content of the storage media is prevented whenever the same information is obtained from different LDSs, and/or whenever the same SCs are obtained from read operation of different types of LDSs.

According to one preferred embodiment of the invention the LDSs are placed in locations on the digital media which are not associated with any file or other content of the digital media.

According to another preferred embodiment of the invention two different LDSs placed in predetermined locations on the digital media and a authentication module performs an authentication procedure whenever the content of the digital media is accessed. A first and a second read operations are performed by the authentication module from the location in which the LDSs are located, the SCs obtained are stored in a memory, and if the retrieved data matches the data expected to be obtained from the LDSs and different SCs are obtained, allowing the access to the content of the digital media.

Optionally, the storage media is a CD-ROM.

According to yet another preferred embodiment of the invention the LDSs contains one or more of the following logical errors:
Type 1—EDC and ECC fields of error correcting code are zeroed;
Type 2—a negative Rom Skew; and
Type 3—the sector number in the header is zeroed.

According to other preferred embodiment of the invention the first LDS contains a logical error of Type 1, and the second LDS contains a logical error of Type 2.

### DETAILED DESCRIPTION OF PREFERRED EMBODIMENTS

The present invention provides a method for differentiating between a copied storage medium and an original, based on locating a set of different signatures on the storage medium, where for each of said signatures an error reading code is retrieved. The determination between a copy and an original is based on a careful comparison of the SCs (error codes) received.

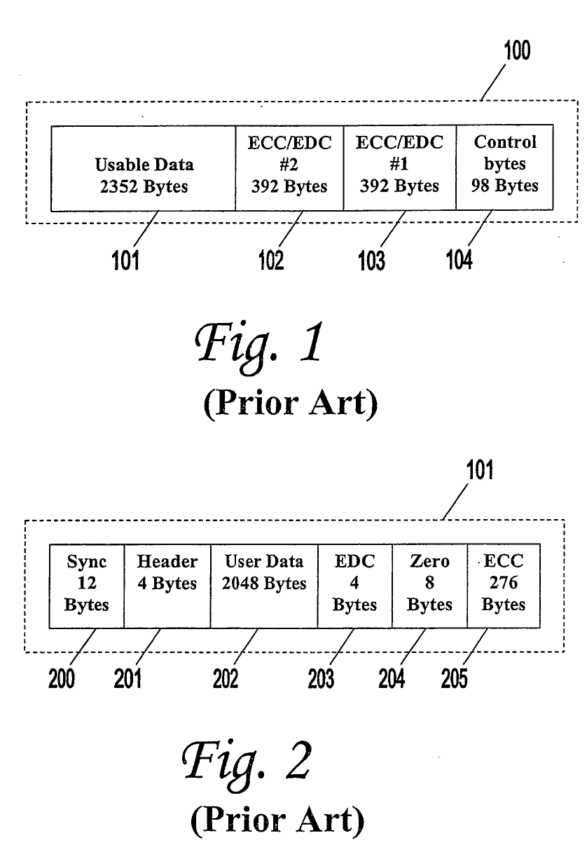

FIG. 1 shows the sector format of CD-DA (Audio CD) (According to Compact Disc System Description—Philips—Holland “Red Book Standards”). Every sector 100 contains 2352 bytes of usable data 101, also known as the main channel information. In audio CD's this area is used to store the music information. In addition to the usable data 101 there are two areas, 102 and 103, which are used for detection and correction of errors that can be caused by dust or scratches on the CD surface (or any other possible cause for a read error). The last field is the control field 104 that contains 98 control bytes per sector, which are divided into 8 sub-channel information fields marked by the letters P through W. The P sub channel indicates whether music or computer data is found on the sector. The Q sub channel contains timing information and sub channels R through W contains information for synchronization and error correction.

FIG. 2 shows the structure of the main channel data field 101 of a CD-ROM recorded in mode 1 (Compact Disc Read Only Memory System Description—Philips—Holland “Yellow Book Standards”). CD-ROM Mode 1 allows recording of computer files only. This data block represents the usable data field 101 of the CD. When CD's were adopted for storing computer information, a more robust error correction and detection system was required. In audio CD's if several bits are corrupted the user most probably will not even notice the corruption or distortion of the music. However, in computers, even a single corrupted bit can make the entire data on the CD useless. In order to make the information on the CD more resistant to errors, such as those caused by dust or scratches for instance, additional fields (280 bytes) for error detection and correction, based on a Cross Interleaved Read-Solomon Code (CIRC), were allocated within the usable data field 101. These fields are also known as layered ECC/EDC (Error Correction Code/Error Detection Code) because they are layered on the usable data field 101. In addition to the layered ECC (205) and EDC (203) fields, a synchronization pattern (200) of 12 bytes and a header (201) of 4 bytes that stores timing and data type information are located within each Usable data section 101 of the sector 100. There are 8 bytes of the Usable data field (204) that are not used in CD-ROMs, and thus set to zero. All the extra information added to the CD-ROM sector format leaves only 2048 bytes for User Data (202).

The invention provides a method for authenticating a storage media which is based on generating two or more different Logical Digital Signatures (LDS), by manipulating the CD-ROM mode 1 data block format. Each signature causes an error (hereinafter also termed logical errors) when a reading attempt from the locations in which these errors (LDSs) are located is made. Because the signatures are actually causing logical errors (i.e., incorrectness in the content of the User Data 202), and not physical errors (e.g., scratches, dust, etc.), CD readers are able to read the information in the Usable Data section 101, but can not retrieve the User Data information 202 and/or verify its accuracy, due to manipulation of the logical data block format. Since each signature cause a different type of logical error, the SCs returned for each signature is also different, as will be discussed herein after.

The ISO 9660 standard defines the file system structure for CD-ROM. According to the ISO 9660 standard every CD-ROM contains at least one volume descriptor and file entries associated with it. The volume descriptor contains information concerning the CD such as its name (volume identifier) and length of data that is written on it, and other information that is required for an operating system in order to use the CD. Every file entry corresponds to a data file on the CD and contains information such as its name size and starting location. Without deviating from the ISO 9660 standard, it is possible to create a CD in which some sectors are not allocated to files. Consequently, the sum of sectors that are allocated to files as written in the file entries will be less than the actual number of sectors written on the CD as reported in the volume descriptor.

Since all signatures of the current invention are based on manipulations of the logical data structure that cause read errors, the signatures are written to the sectors on the CD that are not allocated to data files. This way the readability of the data files is maintained and the signatures are somewhat hidden.

Logical Digital Signatures (LDSs)

Three different LDS Types are described in details and discussed herein below. As will be explained and exemplified herein later, such LDSs can be used in different combinations and detection arrays to validate the originality of a storage medium, and particularly intended for the use with CD-ROMs. It should be noted that the LDS Types described herein below is provided herein only for the purpose of illustration, and are not limiting the invention to LDS of those types specifically. The method of the invention, as will be understood by those having skills in the art, may be carried utilizing other LDS Types, in various combinations and detection arrays.

Type 1 (LDS#1)—this type of LDS is generated by writing a data block in which the EDC and ECC fields (203 and 205) are filled with zeros. In this case the CD reader will read the information, calculate a new EDC code and compare it to the stored EDC value 203. Since the stored EDC value (203) is different from the calculated EDC value, the reader assumes in this case that the information that was read is corrupted and accordingly will try to correct it using the ECC code 205. In this case however, there will be too many errors than the CIRC can correct, and the reader will fail to fix them. Therefore, in this case the Usable Data 101 is retrieved together with a SC which reports that there was a read error.

Type 2 (LDS#2)—this type of LDS is generated by modifying the header field 201. The header field 201 contains the number of the sector and the mode in which the sector is written. The sector number is stored in 3 bytes that represent the exact sector location in the CD (Minute, Second, Frame). The Q sub channel also contains timing information but it is shifted a bit from the main channel timing information (i.e., located in the header 201). The time difference between the Q sub channel and the main channel is called “Rom Skew” and it must be always positive (i.e., Rom Skew=T_{(Q channel)}−T₍ₘₐᵢₙ_{_{—}}_{channel)}>0).

When a CD reader seeks a specific sector for read operation the reader scans the CD using the Q sub channel timing information of each sector 100 for the specific sector number required. When the specific sector number is encountered the reader starts scanning the main channel 101 of each sector, by sequentially reading sector after sector until the required sector number appears in the header field 201 of the sector being read. This is the reason why the “Rom Skew” must always be positive. Namely, the Q sub channel timing information must be behind the main channel timing information. In order to create the third signature, the header field 201 of a sector is changed to indicate a sector number which is much greater than it should be, thus creating a negative Rom Skew (i.e. T₍ₘₐᵢₙ_{_{—}}_{channel)}>>T_{(Q channel)}).

When the reader tries to read the required sector it performs a search by scanning the Q sub channel information for the required sector number. When the required sector number is encountered within the Q sub channel of a sector, the reader scans the main channel information 101 of the following sectors until a sector with the specific number written in its header 201 is encountered. In this case however such a sector will not be encountered and the read operation thus fails. Consequently, the SC reports an error, but in this case however the stored information is not retrieved.

Type 3 (LDS#3)—this type of LDS is generated by zeroing the timing information in the header field 201, without updating the ECC and EDC fields (205 and 203). The result is a sector 100 with errors in the header field bytes 201. The result of a read operation from an area where this signature occurs depends on the reading drive capabilities of detecting and reporting errors. The reading drive can correct the errors in the information using the ECC and EDC codes and the error correction algorithm which is embedded into its firmware. Some drives are able to correct and retrieve the information but will ignore the fact that the error is located in the timing information. Other types of CS drives that are more capable of detecting and reporting errors, will read the information, detect that there is an error in the timing information and report the detected error without transmitting the information back to the initiator (the reading software/computer).

There are 3 types of methods which are mainly used for copying a CD:
1. File Copy—copying all the files on the original CD-ROM to a local storage device (e.g., hard disk) and mastering a new CD using a standard burning software;
2. CD to CD—Using a duplication software that reads all the sectors of the original CD-ROM and writes them to the destination CD. In this method the software reads only the User Data 202 from each sector (2048 bytes per sector); and
3. Raw CD copying (“Cloning”)—Similar to CD to CD copying method but in this method the software reads and writes the raw Usable Data (2352 bytes) field 101 information that includes also the Sync 200, Header 201, EDC 203 and ECC 205 fields, and the User Data 202. Software that utilize this copying mode are also known as cloning software.

According to a preferred embodiment of the invention the LDSs are written in sectors that are not allocated to files. Thus, the copying of a CD that is protected by an array of LDSs, using the file copy method, results in a CD copy that contains no LDSs. The absence of the LDSs from the copied CD is due to the mode of operation which is used by the file copy method, wherein only the information that us associated with files is copied.

On the other hand, when attempting to copy the same protected CD using the CD to CD method, the copying software copies all of the sectors one by one until it reaches the sectors containing the LDSs. Those sectors are unreadable and as was previously discussed, in some cases the User Data 202 can not be retrieved from them. Therefore, the copying software will receive read errors and the copy operation will fail.

When attempting to copy the same protected CD using the cloning method the result depends on the reading drive and the cloning software. Cloning softwares are designed to ignore read errors and write the exact information that was retrieved when reading from the source media. If read errors occur during the read operation and the information can not be retrieved, these software usually generates their own erroneous information and writes it to the destination media, regardless of the information on the source media. Cloning softwares are designed to make exact 1:1 copies mainly for the purpose of copying copyrighted information. These softwares are used to attempt to create a copy that operates as closest as possible to the original media. Therefore, as a result of writing erroneous information to sectors on the destination that corresponds to unreadable sectors on the source media, so that the copy that is obtained is almost identical to the original source from which it is copied. Cloning software differ from one another by the way they handle read errors. Some cloning softwares writes the retrieved information even when read errors occur, while others writes erroneous information even if the information from the source media was retrieved successfully.

According to one preferred embodiment of the invention the LDSs are located in predetermined locations on the storing media, and each LDS also includes a unique signature. The protected content is stored on the storing media together with an authentication module that is programmed to read the information stored in said predetermined locations. The authentication module also includes the unique signature information of each LDS, thus it is capable of authenticating the storing media by checking the SCs obtained due to read operations performed in the LDSs locations and by comparing the information read from the LDSs locations (if retrieved) with the unique signatures that they should include (expected data). The authentication module can be integrated into executable programs stored on the storing media authenticating the storing media whenever said executable programs are activated by the user.

Every cloning software that is unable to read signatures from an original CD, replaces them with a constant pattern of erroneous information on the copy. Therefore the occurrence of two or more different LDSs on the original media are translated by the Cloning Software to two or more unreadable areas on the copy that contains the same constant pattern and causes the reading drive to return the same SC when reading them.

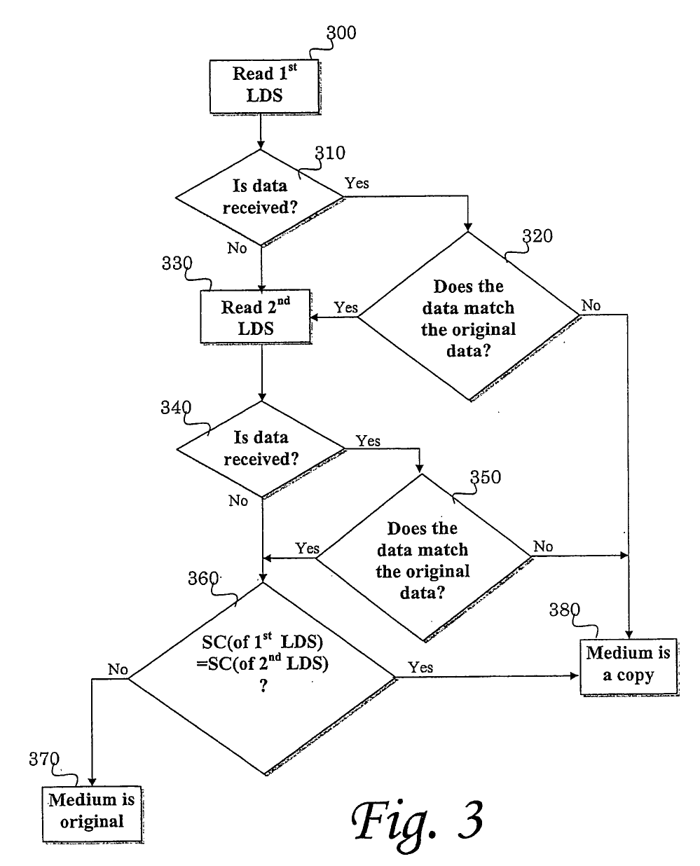

FIG. 3 illustrates the operation of a general detection process, according to the method of the invention that is used by the authentication module to detect whether a storage medium is original or not based on the existence of two different LDSs that cause the reading drive to return two different SCs. It should be noted that the detection process illustrated in FIG. 3 is not limited to a specific storage media, and may be applied to a wide variety of storage medias (e.g., CD, DVD, Magnetic medias, etc.).

In step 300 the first LDS (any type of LDS) is read and the SC obtained is stored in memory. In step 310 it is checked if any data was retrieved as a result of the read operation in step 300. If data was retrieved the control is passed to step 320, else, if data was not retrieved the process proceeds to step 330. In step 320 it is checked if the retrieved data match the data (the LDS unique signature) that was written to the specific location on the original medium. If the retrieved data does not match the unique signature expected, then the medium is certainly a copy and the control is passed to step 380. If the read data and the unique signature expected matches, the control is passed to step 330. The main purpose of steps 310 and 320 is to make sure that a cloning software did not replace the original signature with its own erroneous information.

In step 330 the second LDS (which is of a different type than the first LDS) is read and the returned error is stored in memory. In step 340 it is checked if data was retrieved as a result of the read operation performed in step 330. If data was retrieved the control is passed to step 350, and if no information was retrieved, the process proceeds to step 360. In step 350 it is checked if the retrieved data matches the data that was written to the specific location on the original medium (the unique signature). If the data retrieved in step 330 and the expected unique signature does not match then the medium is certainly a copy and the control is passed to step 380. On the other hand, if the data retrieved in step 330 and the expected unique signature matches, control is passed to step 360.

In Step 360 the SC returned in step 300 (from the 1^{st} LDS) is compared to the SC returned in sector 330 (from the 2^{nd} LDS). If the same SCs were obtained than it is assumed the two different logical signatures on the original medium were replaced with the same erroneous information by a cloning software and the medium is definitely a copy. In this case the control is passed to step 380 and the use of the medium is denied. If the two SCs are not equal, than the two signatures are different and the medium is an original. In this case the control is passed to step 370 and the use of the medium is permitted.

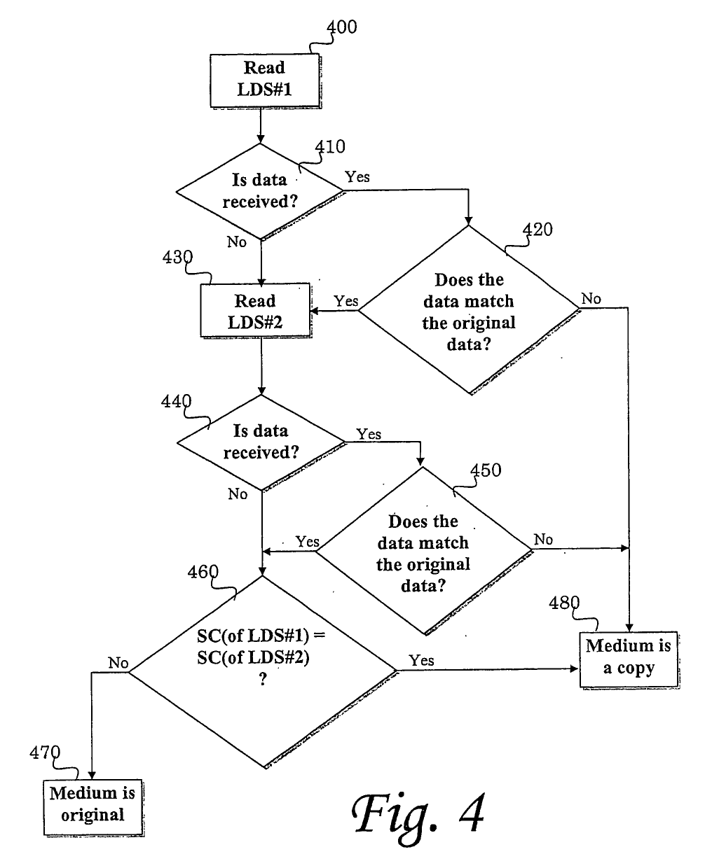

FIGS. 4 illustrates a detection process for CD-ROM, according to the method of the invention that is used to detect whether a storage medium is original or not based on the existence of two different LDSs that cause the reading drive to return two different SCs.

According to a preferred embodiment of the invention a set of LDSs of different types are placed in different locations on the CD. The detection software performs an authentication process in which the presence of each LDS is examined based on the properties of each LDS type.

In step 400 (FIG. 4) the authentication module attempts to read a LDS of Type 1 (LDS#1—generated by zeroing the EDC and ECC fields 203). In Step 410 it is checked if the User Data 202 of the read sector, wherein this unique signature is placed, was retrieved.

If it is determined in step 410 that the content of the User Data 202 was retrieved the control is passed to step 420 wherein it is checked if the retrieved data is the original unique signature data that was written to that location on the original CD. If it is determined in step 420 that the retrieved data does not match the original unique signature data then it is determined that the signature was replaced by a copying software with other information, erroneous or not, and the CD is definitely a copy. On the other hand, if it is determined in step 420 that the retrieved data match the original unique signature data then the authentication process proceeds as the control is passed to step 430.

In step 430 another LDS, of Type 2, is read (LDS#2—having a Negative “Rom Skew”), and the returned SCs is then stored in memory. In step 440 it is checked if data was retrieved as a result of the read operation that was performed in step 430. If it is determined in step 440 that data was not received, the control is passed to step 460, otherwise, if it is determined that data was received, the control is passed to step 450 where it is checked if the received data match the original data that was written to the original CD. If it is determined in step 450 that the received data does not match to the original data then the CD is definitely a copy. On the other hand, if it is determined in step 450 that the received data match to the original data then the control is passed to step 460.

In Step 460 the SC returned in step 400 is compared to the SC returned in step 430. If the two SCs equal than it is assumed the two different logical signatures on the original medium were replaced with the same erroneous information by a cloning software and the medium is definitely a copy. In that case the control is passed to step 480 and the use of the medium is denied. If the two SCs are not equal, than the two signatures are different and the medium is an original. In that case the control is passed to step 470 and the use of the medium is permitted.

As was previously explained, the information stored in LDS#2 is not retrieved when a read attempt is performed. The test performed in step 450 is therefore optional, and it is provided in order to obtain an improved detection process in case new CD-ROMs in the future will be able to obtain the information stored in such LDSs. It is therefore possible to simplify the detection process illustrated in FIG. 4, by removing step 450 and issuing determining that the CD is a copy whenever it is determined in step 440 that data was retrieved.

The above examples and description have of course been provided only for the purpose of illustration, and are not intended to limit the invention in any way. As will be appreciated by the skilled person, the invention can be carried out in a great variety of ways, employing techniques different from those described above, all without exceeding the scope of the invention.

1. A method for protecting digital media from illegal copying by placing in predetermined locations of said digital media a set of Logical Digital Signatures (LDS), each of which causes retrieval of a different Sense Code (SC) and comprise a different signature, and utilizing an authentication module, which contains, or has access, to said signatures, for detecting the presence of said logical errors, comprising:
a) activating said authentication module whenever the content of said storage media is accessed;
b) performing read operation of the locations wherein said LDSs are located;
c) storing the Sense Code (SC) obtained from each read operation in a memory; and
d) if information was retrieved following the LDS read operation and it matches the information that was originally stored, as accessible by the authentication module, and if different SCs were obtained from the reading operation of the different LDSs, allowing access to the content of said storage media, otherwise preventing the access to the content of said storage media.

2. A method according to claim 1, wherein the access to the content of the storage media is prevented whenever the same information is obtained from different LDSs, and/or whenever the same SCs are obtained from read operation of different types of LDSs.

3. A method according to claim 1, wherein the LDSs are placed in locations on the digital media which are not associated with any file or other content of said digital media.

4. A method according to claim 1, wherein two different LDSs are placed in predetermined locations on the digital media, and wherein an authentication procedure is performed by the authentication module whenever the content of said digital media is accessed, comprising:
a) performing a first read operation from the location in which the first LDS is located, and storing the SC obtained in a memory;
b) checking if data was retrieved by said first read operation, and if data was retrieved and said data does not match the data expected to be obtained from said first LDS preventing access to the content of said digital media;
c) performing a second read operation from the location in which the second LDS is located, and storing the SC obtained in a memory;
d) checking if data was retrieved by said second read operation, and if data was retrieved and said data does not match the data expected to be obtained from said second LDS preventing access to the content of said digital media; and
e) comparing the SCs stored in said memory to determined if the SC was obtained from said first and second read operations, and it is determined that the same SCs were obtained from said first and second read operations preventing access to the content of said digital media, otherwise, if it is determined that different SCs were obtained from said first and second read operations allowing access to content of said digital media.

5. A method according to claim 1, wherein the storage media is a CD-ROM.

6. A method according to claim 5, wherein the LDSs contains one or more of the following logical errors:
Type 1—EDC and ECC fields of error correcting code are zeroed;
Type 2—a negative Rom Skew; and
Type 3—the sector number in the header is zeroed.

7. A method according to claim 4, wherein the first LDS contains a logical error of Type 1, and the second LDS contains a logical error of Type 2.

8. A method according to claim 1, wherein the authentication module is integrated into executable programs stored on the protected digital media.

9. A system for protecting digital media from illegal copying, comprising:
a) a set of Logical Digital Signatures (LDS) being placed in predetermined locations of said digital media;
b) a authentication module being activated whenever the content of said storage media is accessed; and
c) a memory;
wherein said authentication module performs read operations of the locations wherein said LDSs are located to determine if for each read operation a different SC is obtained and to determined if information that was obtained by said read operations corresponds to those expected from said LDSs, in order to allow access to the content of said digital media.

10. A system according to claim 9, wherein the access to the content of the storage media is prevented whenever the same information is obtained from different LDSs, and/or whenever the same SCs are obtained from read operation of different types of LDSs.

11. A system according to claim 9, wherein the LDSs are placed in locations on the digital media which are not associated with any file or other content of said digital media.

12. A system according to claim 9, comprising:
a) two different LDSs placed in predetermined locations on the digital media;
b) a authentication module which performs an authentication procedure whenever the content of said digital media is accessed;
c) a memory;
wherein a first and a second read operations are performed by said authentication module from the location in which said LDSs are located, the SCs obtained are stored in said memory, and data was retrieved by said read operations and the retrieved data matches the data expected to be obtained from said LDSs and different SCs are obtained, allowing the access to the content of said digital media.

13. A system according to claim 9, wherein the storage media is a CD-ROM.

14. A system according to claim 13, wherein the LDSs contains one or more of the following logical errors:
Type 1—EDC and ECC fields of error correcting code are zeroed;
Type 2—a negative Rom Skew; and
Type 3—the sector number in the header is zeroed.

15. A system according to claim 12, wherein the first LDS contains a logical error of Type 1, and the second LDS contains a logical error of Type 2.

16. A system according to claim 9, wherein the authentication module is integrated into executable programs stored on the protected digital media.

17. A protected digital media for preventing illegal copying, comprising:
a. set of Logical Digital Signatures (LDS), placed in predetermined locations of said digital media, where each of said Logical Digital Signatures causes retrieval of a Sense Code (SC) and comprise a signature; and
b. an authentication module, which contains, or has access, to said signatures, for detecting the presence of said logical errors.

18. A protected digital media according to claim 17, wherein the authentication module is integrated into executable programs stored on the protected digital media.

19. A protected digital media according to claim 17, wherein the LDSs are placed in locations on the digital media which are not associated with any file or other content of said digital media.

20. A protected digital media according to claim 17, wherein the storage media is a CD-ROM.

21. A protected digital media according to claim 17, wherein the LDSs contains one or more of the following logical errors:
Type 1—EDC and ECC fields of error correcting code are zeroed;
Type 2—a negative Rom Skew; and
Type 3—the sector number in the header is zeroed.

22. A method according to claim 5, wherein the first LDS contains a logical error of Type 1, and the second LDS contains a logical error of Type 2.

23. A system according to claim 13, wherein the first LDS contains a logical error of Type 1, and the second LDS contains a logical error of Type 2.
